(19) United States
(12) Patent Application Publication
(10) Pub. No.: US 2015/0147510 A1
(43) Pub. Date: May 28, 2015

(54) SUBSTRATELESS DOUBLE-SIDED ADHESIVE SHEET

(71) Applicant: MITSUBISHI PLASTICS, INC., Chiyoda-ku, Tokyo (JP)

(72) Inventor: Tomohisa Saito, Maibara-shi (JP)

(21) Appl. No.: 14/350,150

(22) PCT Filed: Oct. 5, 2012
(86) PCT No.: PCT/JP2012/076019

§ 371 Date: Apr. 7, 2014

(30) Foreign Application Priority Data
Oct. 8, 2011 (JP) 2011-223513

(51) Int. Cl. C09J 7/02

(52) U.S. Cl. CPC C09J 7/0232; C09J 7/0228; C09J 2467/005; C09J 2483/005; C09J 2429/005; C09J 2201/128; C09J 201/00
USPC 428/40.9

(57) ABSTRACT

The present invention provides a substrateless double-sided adhesive sheet having an excellent optical inspection property by suppressing defects owing to foreign matters (such as oligomers) generated during a production process thereof which can exhibit a high productivity based on a high yield in a step of laminating a prepared adhesive sheet onto another member. The present invention relates to a substrateless double-sided adhesive sheet comprising an adhesive layer, a first release film laminated on one surface of the adhesive layer and a second release film laminated on another surface of the adhesive layer, the first release film comprising a biaxially oriented polyester film and a release layer formed on the polyester film, in which the release layer comprises a silicone resin comprising an alkenyl group and alkyl group as functional groups and a migration component, and a platinum-based catalyst, and has a residual adhesion rate of 60 to 90%, a low-speed peel force of 10 to 20 mN/cm as measured at a rate of 300 mm/min, and a high-speed peel force being not more than 2.5 times the low-speed peel force as measured at a rate of 10000 mm/min, and further exhibits a Martens' hardness of not less than 400 N/mm² as measured at a testing force of 0.10 mN using a triangular pyramid indenter with an apex angle of 115°.

### TECHNICAL FIELD

The present invention relates to a substrateless double-sided adhesive sheet, and more particularly, to a substrateless double-sided adhesive sheet having an excellent productivity, in particular, upon lamination with an adhesive in a production process which can be suitably used in optical applications, for example, such as touch panels, liquid crystal displays (hereinafter also referred to merely as “LED”), plasma display panels (hereinafter also referred to merely as “PDP”) and organic electroluminescent devices (hereinafter also referred to merely as “organic EL”).

Conventionally, there are known various adhesive sheets serving for adhesion between surfaces of members. As one kind of adhesive sheets, there are known substrateless double-sided adhesive sheets. The substrateless double-sided adhesive sheets are constituted of a light-peel sheet having a relatively low peel force and a heavy-peel sheet having a relatively high peel force which are bonded to both surfaces of the adhesive layer, and after removing both the peel sheets form the double-sided adhesive sheet, there remains only the adhesive layer having no supporting substrate. In the substrateless double-sided adhesive sheet, the light-peel sheet is first peeled off to expose one surface of the adhesive layer, and after bonding the exposed one surface of the adhesive layer to a surface of an objective body, the heavy-peel sheet is further peeled off to expose another surface of the adhesive layer which is bonded to a surface of a different body, so that these bodies are surface-bonded to each other.

In recent years, the substrateless double-sided adhesive sheets have been used in more extensive applications, and can be applied to members used in various optical applications. For example, as members for LCD, the substrateless double-sided adhesive sheets are used in such a manner that a light-peel side release film thereof is peeled off to laminate a polarizing plate thereon, and a release film having a heavy-peel force is provided on an opposite surface of the sheet.

In order to attain a good workability in view of productivity, it might be considered that the processing is conducted at a certain high speed range. Although it is, as a matter of course, important to allow a light-peel side release film to have a lighter-peel force, even if the processing speed increases, it may be very difficult to achieve prevention of reduction in difference between peel forces of the light-peel release film and the heavy-peel release film simultaneously with achieving the light peel force of the light-peel side release film (Patent Document 1). If the difference between peel forces of the heavy-peel side and light-peel side release films is reduced, there tend to arise such a problem that both the films are peeled off at the same time in the peeling step, or such a problem that an adhesive is also peeled off together with the release films owing to the less difference between peel forces thereof, thereby causing defects such as a poor processability and a low productivity (Patent Document 2).

It is very difficult to control the difference between peel forces of the release films, and therefore it is necessary to suitably select and control various silicone components (Patent Documents 1 and 2). Further, it is also considered that the resulting silicone coating film must be controlled in hardness.

In addition, in the applications in which the substrateless double-sided adhesive sheet is used in an outside portion of a touch panel or a flat panel having a relatively small monitor area, the obtained products tend to be disposed and used close to the user's eyes. For this reason, if there are present any noticeable luminescent spots such as foreign matters, there tend to occur visual disturbance or defects, thereby causing necessity of further enhancing an accuracy of inspection work. In this case, the substrateless double-sided adhesive sheet may be sometimes subjected to such an inspection while the release films are kept attached thereto. In such a case, it is necessary not only to as a matter of course reduce foreign matters attached to the films, but also to control an optical axis of the films, i.e., orientation of molecules thereof to facilitate the inspection (Patent Document 3).

Further, as one of the above foreign matters, there may be mentioned low-molecular components called oligomers which are derived from a polyester film (the oligomers are hereinafter referred to merely as OL). If generation of OL can be prevented, it is possible to suppress occurrence of defects owing to the foreign matters upon production of the film, and further prevent contamination of the films and subsequent steps in the process. Meanwhile, in the present invention, OL is defined as a cyclic trimer among low-molecular weight products crystallized and deposited on a surface of the films after heat treatment thereof.

### CITATION LIST

### Patent Literature

Patent Document 1: Japanese Patent Application Laid-Open (KOKAI) No. 2009-220496
Patent Document 2: Japanese Patent Application Laid-Open (KOKAI) No. 10-158519
Patent Document 3: Japanese Patent Application Laid-Open (KOKAI) No. 2003-231214

### SUMMARY OF THE INVENTION

### Problems to be Solved by the Invention

The present invention has been accomplished to solve the above conventional problems. An object of the present invention is to provide a substrateless double-sided adhesive sheet that is capable of minimizing a peel speed dependency when used in the optical applications, for example, such as touch panels, liquid crystal polarizing plates and retardation plates, solving problems such as productivity and costs, and preventing generation of OL and imparting a good inspection property thereto, whereby it is contemplated to suppress contamination of the process and reduce foreign matters attached to adhesives.

### Means for Solving Problems

As a result of the present inventors' earnest study in view of the above problems, it has been found that the above problems can be readily solved by using a double-sided adhesive sheet having a specific structure. The present invention has been attained on the basis of this finding.

That is, in an aspect of the present invention, there is provided a substrateless double-sided adhesive sheet comprising an adhesive layer, a first release film laminated on one surface of the adhesive layer and a second release film laminated on another surface of the adhesive layer, which first release film comprises a biaxially oriented polyester film and a release layer formed on the polyester film,

which release layer comprises a silicone resin comprising an alkenyl group and alkyl group as functional groups and a migration component, and a platinum-based catalyst, and

which release layer has a residual adhesion rate of 60 to 90%, a low-speed peel force of 10 to 20 mN/cm as measured at a rate of 300 mm/min, and a high-speed peel force being not more than 2.5 times the low-speed peel force as measured at a rate of 10000 mm/min, as well as a Martens' hardness of not less than 400 N/mm² as measured at a testing force of 0.10 mN using a triangular pyramid indenter with an apex angle of 115°.

In a preferred embodiment of the present invention, there is also provided the substrateless double-sided adhesive sheet having a layer structure further comprising a coating layer obtained by applying a coating solution comprising polyvinyl alcohol between the polyester film and the silicone-based release layer.

### Effect of the Invention

According to the present invention, there is provided a substrateless double-sided adhesive sheet having an excellent optical inspection property by suppressing occurrence of defects owing to foreign matters (such as, for example, oligomers) generated during a production process thereof which can exhibit a high productivity based on a high yield in a step of laminating a prepared adhesive sheet onto another member.

### BRIEF DESCRIPTION OF THE DRAWING

FIG. 1 is a sectional view schematically showing a substrateless double-sided adhesive sheet according to an embodiment of the present invention.

### PREFERRED EMBODIMENTS FOR CARRYING OUT THE INVENTION

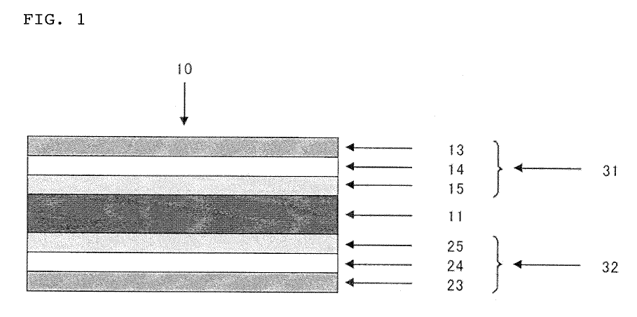

As shown in FIG. 1, a substrateless double-sided adhesive sheet 10 comprises an adhesive layer 11, and a first release film 31 and a second release film 32 which are laminated on opposite surfaces of the adhesive layer 11.

The first release film 31 is a so-called light-peel sheet, and has a laminated structure comprising a release film substrate 13 formed of a polyester film, a coating layer 14 and a first release agent layer 15. The first release agent layer 15 is peelably tack-bonded onto the adhesive layer 11.

The second release film 32 is a so-called heavy-peel sheet, and has a laminated structure comprising a release film substrate 23 formed of a polyester film, a coating layer 24 and a second release agent layer 25. The second release agent layer 25 is peelably tack-bonded onto the adhesive layer 11. The coating layer 24 may be provided in an especially preferred embodiment of the present invention.

### <Polyester Film>

The polyester film used as a substrate of the respective release films in the present invention is a film produced by drawing a sheet melted and extruded from an extrusion die according to a so-called extrusion method.

The polyester constituting the above film means a polymer comprising an ester group which may be obtained by polycondensing a dicarboxylic acid and a diol or a hydroxycarboxylic acid. Examples of the dicarboxylic acid include terephthalic acid, isophthalic acid, adipic acid, azelaic acid, sebacic acid, 2,6-naphthalenedicarboxylic acid and 1,4-cyclohexanedicarboxylic acid. Examples of the diol include ethylene glycol, 1,4-butanediol, diethylene glycol, triethylene glycol, neopentyl glycol, 1,4-cyclohexanedimethanol and polyethylene glycol. Examples of the hydroxycarboxylic acid include p-hydroxybenzoic acid and 6-hydroxy-2-naphthoic acid. Typical examples of such a polymer as the polyester include polyethylene terephthalate and polyethylene-2,6-naphthalate.

For the purpose of mainly imparting an easy-slipping property to the film and preventing occurrence of flaws in the film during the respective steps, particles are preferably compounded in the film. The kinds of particles to be compounded in the film are not particularly limited as long as the particles are capable of imparting a good easy-slipping property to the film. Specific examples of the particles include particles of silica, calcium carbonate, magnesium carbonate, barium carbonate, calcium sulfate, calcium phosphate, magnesium phosphate, kaolin, aluminum oxide, titanium oxide, etc. In addition, there may also be used heat-resistant organic particles as described in Japanese Patent Publication (KOKOKU) No. 59-5216, Japanese Patent Application Laid-Open (KOKAI) No. 59-217755 or the like. Examples of the other heat-resistant organic particles include particles of thermosetting urea resins, thermosetting phenol resins, thermosetting epoxy resins, benzoguanamine resins, etc. Further, there may also be used deposited particles obtained by precipitating and finely dispersing a part of metal compounds such as a catalyst during the process for production of the polyester.

On the other hand, the shape of the particles is also not particularly limited, and may be any of a spherical shape, a massive shape, a bar shape, a flat shape, etc. Further, the hardness, specific gravity, color and the like of the particles are also not particularly limited. These particles may be used in combination of any two or more kinds thereof, if required.

The average particle diameter of the particles is usually in the range of 0.01 to 3 μm and preferably 0.1 to 2 μm. When the average particle diameter of the particles is less than 0.01 μm, the particles may fail to impart a sufficient easy-slipping property to the film. On the other hand, when the average particle diameter of the particles is more than 3 μm, the film not only tends to be deteriorated in transparency owing to aggregation of the particles but also tends to suffer from breakage upon formation of the film, thereby causing the problems concerning a productivity of the film.

The content of the particles in the film is usually in the range of 0.001 to 5% by weight and preferably 0.005 to 3% by weight. When the content of the particles in the film is less than 0.001% by weight, the resulting film tends to be insufficient in easy-slipping property. On the other hand, when the content of the particles in the film is more than 5% by weight, the resulting film tends to be insufficient in transparency.

The method of compounding the particles in the film is not particularly limited, and any conventionally known methods can be suitably used therefor. For example, the particles may be added at any optional stages in the process for production of the polyester. The particles are preferably added to the polyester after completion of the esterification reaction or transesterification reaction.

In addition, there may also be used the method of blending a slurry of the particles prepared by dispersing the particles in ethylene glycol or water with the polyester raw material using a vented kneading extruder, the method of blending the dried particles with the polyester raw material using a kneading extruder, or the like.

Meanwhile, the film used in the present invention may also comprise, in addition to the above particles, conventionally known additives such as an antioxidant, an antistatic agent, a thermal stabilizer, a lubricant, a dye, a pigment, etc., if required.

The thickness of the polyester film used in the present invention is not particularly limited as long as it lies within any suitable range capable of forming a film shape, and is usually in the range of 10 to 350 μm, preferably 38 to 125 μm and more preferably 50 to 100 μm. When the thickness of the film is less than 10 μm, foreign matters generated in the process upon processing the adhesive sheet in the present application field tend to be transferred onto the adhesive sheet. In addition, upon processing the release film, there tends to arise such a problem that the film is deteriorated in coatability, resulting in poor productivity thereof. When the thickness of the film is excessively large, there also tends to occur the problem of increase in costs.

Next, an example of the process of producing the polyester film used in the present invention is more specifically explained, although the present invention is not particularly limited thereto. That is, in the production process, there is preferably used such a method in which the above-mentioned polyester raw material is extruded from a die in the form of a molten sheet, and the molten sheet is cooled and solidified on a chilled roll to obtain an undrawn sheet. In this case, in order to enhance a flatness of the sheet, it is preferred to enhance adhesion between the sheet and a rotary chilled drum. For this purpose, an electrostatic pinning method and/or a liquid coating adhesion method are preferably used. Next, the thus obtained undrawn sheet is biaxially drawn. In such a case, the undrawn sheet is first drawn in one direction thereof using a roll-type or tenter-type drawing machine. The drawing temperature is usually 90 to 140° C. and preferably 95 to 120° C., and the draw ratio is usually 2.5 to 7 times and preferably 3.0 to 6 times. Next, the thus drawn film is drawn in the direction perpendicular to the drawing direction of the first stage. In this case, the drawing temperature is usually 90 to 170° C., and the draw ratio is usually 3.0 to 7 times and preferably 3.5 to 6 times. Successively, the resulting biaxially drawn sheet is subjected to heat-setting at a temperature of 180 to 270° C. under a tension or relaxation within 30% to obtain a biaxially oriented film. Upon the above drawing step, there may also be used the method in which the drawing in each direction is carried out in two or more stages. In such a case, the multi-stage drawing is preferably performed such that the draw ratio in each of the two directions finally falls within the above-specified range.

Also, upon producing the polyester film, there may also be used a simultaneous biaxial drawing method. The simultaneous biaxial drawing method is such a method in which the above undrawn sheet is drawn and oriented in both of the machine and width directions at the same time while maintaining the sheet in a suitable temperature-controlled condition at a temperature of usually 90 to 140° C. and preferably 80 to 110° C. The draw ratio used in the simultaneous biaxial drawing method is 4 to 50 times, preferably 7 to 35 times and more preferably 10 to 25 times in terms of an area ratio of the film. Successively, the obtained biaxially drawn sheet is subjected to heat-setting at a temperature of 170 to 250° C. under a tension or relaxation within 30% to obtain a drawn oriented film. As the apparatus used in the above simultaneous biaxial drawing method, there may be employed those drawing machines of any conventionally known type such as a screw type drawing machine, a pantograph type drawing machine and a linear drive type drawing machine.

### <Coating Layer Formed by Applying a Coating Solution Comprising Polyvinyl Alcohol>

The above coating layer is formed for the purposes of not only providing sealing against OL but also preventing contamination of the process owing to OL as well as contamination of the film when attached to the adhesive layer.

The content of the polyvinyl alcohol in the coating layer is usually 10 to 100% by weight, preferably 20 to 90% by weight, and more preferably 30 to 90% by weight. When the content of the polyvinyl alcohol in the coating layer is less than 10% by weight, the OL sealing effect tends to be insufficient and therefore undesirable.

The polyvinyl alcohol may be synthesized by ordinary polymerization reaction, and is preferably water-soluble. The polymerization degree of the polyvinyl alcohol is not particularly limited, and is usually not less than 100, and preferably 300 to 40000. When the polymerization degree of the polyvinyl alcohol is not more than 100, there is such a tendency that the coating layer is deteriorated in water resistance. The saponification degree of the polyvinyl alcohol is not particularly limited, and is usually not less than 70 mol % and preferably not less than 80 mol %, and is also not more than 99.9 mol %.

In the coating layer, if required, a water-soluble or water-dispersible binder resin other than the polyvinyl alcohol may be used in combination therewith. The binder resin used herein is defined as a high-molecular compound having a number-average molecular weight (Mn) of not less than 1000 as measured by gel permeation chromatography (GPC) and exhibiting a good film-forming property, according to a flow scheme for evaluation of safety of high-molecular compounds (Council of Chemical Substances; November, 1985). Examples of the binder resin include polyesters, polyurethanes, acrylic resins, vinyl resins, epoxy resins, amide resins and acrylate resins. These binder resins may have substantially a composite structure comprising respective skeletal structures formed by copolymerization or the like. Examples of the binder resins having such a composite structure include acrylic resin-grafted polyesters, acrylic resin-grafted polyurethanes, vinyl resin-grafted polyesters, vinyl resin-grafted polyurethanes, and acrylate resin-grafted polyethylene glycols. The binder resin is compounded in the coating layer in an amount of not more than 50 parts by weight and preferably not more than 30 parts by weight based on the weight of the coating layer.

Further, the coating layer may comprise a crosslinking reactive compound, if required. The crosslinking reactive compound may be selected from polyfunctional low-molecular compounds and high-molecular compounds such as methylolated or alkylolated urea-based, melamine-based, guanamine-based, acrylamide-based and polyamide-based compounds, polyamines, epoxy compounds, oxazoline compounds, aziridine compounds, blocked isocyanate compounds, silane coupling agents, titanium coupling agents, zircoaluminate-based coupling agents, metal chelates, organic acid anhydrides, organic peroxides, heat-reactive or photoreactive vinyl compounds and photosensitive resins.

The crosslinking reactive compound undergoes crosslinking reaction with a functional group of the resin contained in the coating layer to thereby improve an agglomerating property, a surface hardness, a mar resistance, a solvent resistance and a water resistance of the coating layer. For example, in the case where the functional group of the easy-bonding resin is a hydroxyl group, as the crosslinking reactive compound, there are preferably used melamine-based compounds, blocked isocyanate compounds, organic acid anhydrides or the like. Also, in the case where the functional group of the easy-bonding polyester is an organic acid group or an organic acid anhydride group, as the crosslinking reactive compound, there are preferably used epoxy-based compounds, melamine-based compounds, oxazoline-based compounds, metal chelates or the like. In addition, in the case where the functional group of the easy-bonding resin is an amine group, as the crosslinking reactive compound, there are preferably used epoxy-based compounds or the like. Thus, the crosslinking reactive compound used is preferably selected from those compounds having a higher efficiency of crosslinking reaction with the functional group of the easy-bonding resin. Examples of the melamine compounds include alkylolated or alkoxyalkylolated melamine-based compounds such as methoxymethylated melamines and butoxymethylated melamines. In addition, those compounds obtained by subjecting urea, etc., to co-condensation with a part of melamine may also be used as the melamine compounds.

The crosslinking reactive compound may be in the form of either a low-molecular weight compound or a reactive functional group-containing high-molecular weight polymer as long as the compound comprises two or more reactive functional groups in a molecule thereof. The crosslinking reactive compound may be compounded in the coating layer in an amount of not more than 50 parts by weight, preferably not more than 30 parts by weight and especially preferably not more than 15 parts by weight based on the weight of the coating layer.

In the case where the binder resin and the crosslinking agent are compounded with each other at an optional mixing ratio, the coating layer forms a dense barrier layer so that it is possible to more effectively suppress deposition of OL thereon. Therefore, the addition of the crosslinking reactive compound has the effect of possibly preventing deposition of OL from the polyester film onto the adhesive or generation of OL in the subsequent processing step.

The coating layer may also comprise inert particles in order to improve a slipping property thereof. Examples of the inert particles include inorganic inert particles and organic inert particles. Specific examples of the inorganic inert particles include silica sol, alumina sol, calcium carbonate and titanium oxide. Specific examples of the organic inert particles include fine particles comprising homopolymers or copolymers of polystyrene reins, polyacrylic resins, polyvinyl resins or the like, or organic particles such as, typically, composite crosslinked particles formed of a composite of the above fine particles and a crosslinking component. These inert particles preferably have a softening temperature or decomposition temperature of not lower than about 200° C., more preferably not lower than 250° C. and still more preferably not lower than 300° C. The average particle diameter (d) of the inert particles is preferably determined so as to satisfy the relationship of ⅓≦d/L≦3 and more preferably ½≦d/L≦2 wherein (L) represents an average film thickness of the coating layer.

The coating layer may also comprise various additives such as a surfactant, a defoaming agent, a coatability improver, a thickening agent, a low-molecular antistatic agent, an organic lubricant, an antioxidant, an ultraviolet absorber, a foaming agent, a dye and a pigment in a small amount, if required. These additives may be used alone or in combination of any two or more thereof. The coating layer may be formed on one surface of the polyester film or both surfaces of the polyester film. When the coating layer is formed on only one surface of the polyester film, another kind of coating layer may be formed on the opposite surface of the polyester film to further impart other properties thereto. Meanwhile, in order to improve a coatability of a coating solution onto the film and adhesion of the resulting coating layer thereto, the film may be subjected to chemical treatments or discharge treatments prior to forming the coating layer thereon.

The coating solution used for forming the coating layer in the present invention is preferably prepared by using water as main medium usually from the standpoint of safety or hygiene. The coating solution may also comprise a small amount of an organic solvent for the purpose of improving a dispersibility in water or a film-forming property as far as the coating solution is prepared using water as a main medium. The organic solvent is preferably used in an amount capable of being dissolved in water when used in the form of a mixture with water as the main medium. However, the organic solvent may also be undissolved in water upon use as long as the organic solvent is present in the form of a stable emulsion that is free from separation into individual layers even when allowed to stand for a long period of time. The organic solvents may be used singly, or in combination of any two or more kinds thereof, if required.

As the method of applying the coating solution on the surface of the polyester film, there may be used conventionally known coating methods as described in Yuji HARAZAKI, “Coating Methods”, Maki-shoten, 1979, such as those methods using a reverse roll coater, a gravure coater, a rod coater, an air doctor blade coater, etc.

The method of forming the coating layer is not particularly limited. However, there may be suitably adopted the method of applying a coating solution during the step of producing the polyester film (in-line coating method). More specifically, there may be mentioned the method in which the coating solution is applied on the surface of the undrawn sheet and then dried, the method in which the coating solution is applied on the surface of the monoaxially drawn sheet and then dried, and the method in which the coating solution is applied on the surface of the biaxially drawn sheet and then dried. Among these methods, in view of economy, there is preferably used the method in which after applying the coating solution onto the surface of the undrawn or monoaxially drawn film, the coating layer is dried and cured simultaneously with the step of subjecting the film to heat-setting. In addition, the coating layer may be formed by combination of some of the above-mentioned coating methods according to the requirements. More specifically, there may be mentioned the method in which the first layer is applied on the surface of the undrawn sheet and dried, and thereafter the resulting sheet is drawn in one axial direction thereof, and further the second layer is applied thereonto and dried.

When forming the coating layer by in-line coating method, the laminated polyester film is preferably produced by the method in which an aqueous solution or a water dispersion of a series of the above-mentioned compounds is prepared as a coating solution having a concentration of about 0.1 to about 50% by weight in terms of a solid content thereof, and the thus prepared coating solution is applied onto the polyester film. The coating solution may also comprise a small amount of an organic solvent for the purpose of improving a dispersibility in water, a film-forming property, etc., unless the subject matter of the present invention is adversely affected. The organic solvent may be used alone, or two or more organic solvents may be appropriately used in the form of a mixture thereof.

The drying and curing conditions used upon forming the coating layer on the polyester film are not particularly limited. For example, in the case where the coating layer is formed by an in-line coating method, the coating layer may be subjected to heat-setting usually at a temperature of 70 to 280° C. for 3 to 200 sec. The heat-setting may be used in combination with irradiation with active energy rays such as irradiation with ultraviolet rays, if required. The polyester film may be previously subjected to surface treatments such as corona treatment and plasma treatment.

In the case where the release film is provided thereon with the coating layer comprising polyvinyl alcohol, the amount of OL extracted from the surface of the coating layer with dimethyl formamide after subjecting the release film to heat-setting (at 180° C. for 10 min) is preferably not more than 1.0 mg/m². When the amount of OL extracted is more than 1.0 mg/m², there tend occur drawbacks such as process contamination, generation of foreign matters upon lamination with an adhesive and poor yield of products.

The thickness of the coating layer is usually in the range of 0.002 to 1.0 g/m², preferably 0.005 to 0.5 g/m² and more preferably 0.01 to 0.2 g/m². When the thickness of the coating layer is less than 0.002 g/m², the resulting coating layer may fail to exhibit a sufficient adhesion property. When the thickness of the coating layer is more than 1.0 g/m², the resulting coating layer tends to be deteriorated in appearance and transparency, so that the obtained film tends to be deteriorated in anti-blocking property. The analysis of the respective components compounded in the coating layers may be conducted, for example, by surface analysis such as TOF-SIMS.

Meanwhile, in the present invention, the film may have such a laminated structure in which a polyester having a less OL content is co-extruded and laminated on at least one surface of a polyester layer having an ordinary OL content. The release film having such a laminated structure according to the present invention is especially preferred because it can exhibit the effect of preventing occurrence of luminescent spots owing to OL deposited.

### <Release Layer>

The release layer of the present invention is a silicone-based release layer comprising a silicone resin (a) having an alkenyl group as a functional group, a silicone resin (b) having an alkyl group as a functional group, a migration component (c) migrated into the adhesive layer, and a platinum-based catalyst (d).

First, examples of the curing-type silicone resin having an alkenyl group include diorganopolysiloxanes such as dimethylsioxne/methylhexenylsiloxane copolymers end-capped by a trimethylsiloxy group at both ends of a molecular chain thereof (dimethylsiloxane units: 96 mol %; methylhexenylsiloxane units: 4 mol %), dimethylsioxne/methylhexenylsiloxane copolymers end-capped by a dimethylvinylsiloxy group at both ends of a molecular chain thereof (dimethylsiloxane units: 97 mol %; methylhexenylsiloxane units: 3 mol %), and dimethylsioxne/methylhexenylsiloxane copolymers end-capped by a dimethylhexenylsiloxy group at both ends of a molecular chain thereof (dimethylsiloxane units: 95 mol %; methylhexenylsiloxane units: 5 mol %).

Next, examples of the curing-type silicone resin having an alkyl group include organohydrogenpolysiloxanes such as methylhydrogenpolysiloxanes end-capped by a trimethylsiloxy group at both ends of a molecular chain thereof, dimethylsioxne/methylhydrogensiloxane copolymers end-capped by a trimethylsiloxy group at both ends of a molecular chain thereof, methylhydrogenpolysiloxanes end-capped by a dimethylhydrogensiloxy group at both ends of a molecular chain thereof, and dimethylsioxne/methylhydroegensiloxane copolymers end-capped by a dimethylhydrogensiloxy group at both ends of a molecular chain thereof.

The release film of the present invention is used by laminating a release layer thereof onto the adhesive layer of the substrateless double-sided adhesive sheet. The above silicone resin comprises a migration component migrated to the adhesive layer. As the migration component, there may be typically used silicone oils. The silicone oils are generally called straight silicone oils or modified silicone oils. Specific examples of the straight silicone oils include dimethyl silicone oils, methyl phenyl silicone oils and methyl hydrogen silicone oils. Specific examples of the modified silicone oils include side chain-type polyether-modified silicone oils, aralkyl-modified silicone oils, fluoroalkyl-modified silicone oils, long-chain alkyl-modified silicone oils, higher fatty acid ester-modified silicone oils, higher fatty acid amide-modified silicone oils, polyether/long-chain alkyl-modified/aralkyl-modified silicone oils, phenyl-modified silicone oils, both terminal end-type polyether-modified silicone oils, and polyether/methoxy-modified silicone oils. The straight silicone oils and the modified silicone oils are both in the form of a non-reactive non-functional oil.

The content of the migration component in the release layer is 5 to 20% by weight, preferably 10 to 13% by weight and more preferably 0.1 to 5.0% by weight. When the content of the migration component in the release layer is less than 5% by weight, the peel speed dependency of the resulting release layer tends to be increased. When the content of the migration component in the release layer is more than 20% by weight, the release layer tends to be considerably deteriorated in curing property, and tends to suffer from defects such as poor adhesion property.

Specific examples of the silicone-based resin coating agent that may used in the present invention include “KS-774”, “KS-775”, “KS-778”, “KS-779H”, “KS-847H”, “KS-856”, “X-62-2422” and “X-62-2461” all produced by Shin-Etsu Chemical Co., Ltd.; “DKQ3-202”, “DKQ3-203”, “DKQ3-204”, “DKQ3-205” and “DKQ3-210” all produced by Dow Corning Asia Ltd.; “YSR-3022”, “TPR-6700”, “TPR-6720” and “TPR-6721” all produced Toshiba Silicone Co., Ltd.; and “LTC300B”, “LTC303E”, “LTC310”, “LTC314”, “SRX357”, “BY24-749”, “SD7333”, “BY24-179”, “SP7015”, “SP7259”, “SD7220”, “SD7226” and “SD7229” all produced by Dow Corning Toray Co., Ltd. Further, in the release layer, a peel controlling agent may be used in combination with the above silicone resins in order to control a peeling property, etc., of the release layer.

The above silicone-based resin coating agent comprises the silicone resin (a) having an alkenyl group as a functional group, the silicone resin (b) having an alkyl group as a functional group, and the migration component (c) migrated into the adhesive layer. The ratio of the silicone resin (b) having an alkyl group as a functional group to the silicone resin (a) having an alkenyl group as a functional group [(b)/(a)] is usually 0.5 to 2 in terms of a weight ratio therebetween. Meanwhile, in the present invention, there may be used a silicone resin having an alkenyl group and an alkyl group as functional groups thereof.

As the method of forming the release layer on the polyester film, the conventionally known coating methods may be used similarly to those described with respect to the above coating layer. The coating amount of the coating material upon forming the release layer is usually in the range of 0.01 to 1 g/m².

The surface of the polyester film which is opposed to the surface on which the release layer is formed may be provided thereon with an additional coating layer such as an adhesive layer, an antistatic layer and an OL deposition-preventive layer. In addition, the polyester film may be subjected to surface treatments such as corona treatment and plasma treatment.

In the present invention, in order to keep the release layer clean and tough, there is used a platinum-based catalyst capable of promoting an addition-type reaction. Examples of a main component of the platinum-based catalyst include platinum-based compounds such as chloroplatinic acid, an alcohol solution of chloroplatinic acid, a complex of chloroplatinic acid and an olefin, and a complex of chloroplatinic acid and an alkenyl siloxane; and platinum black, platinum-carrying silica and platinum-carrying activated carbon. The content of the platinum-based catalyst in the release layer is usually in the range of 0.3 to 3.0% by weight, and preferably 0.5 to 2.0% by weight. When the content of the platinum-based catalyst in the release layer is less than 0.3% by weight, the peel force tends to be undesirable, and the curing reaction in the coating layer tends to be insufficient, thereby causing defects such as poor surface properties of the resulting layer. On the other hand, when the content of the platinum-based catalyst in the release layer is more than 3.0% by weight, the costs tend to be increased, or the reactivity tends to become excessively high, so that there tend to arise problems such as generation of gels as foreign matters.

Further, in the addition-type reaction having a very high reactivity, acetylene alcohol may be sometimes added as a reaction inhibitor. The main component of the reaction inhibitor is an organic compound having a carbon-carbon triple bond and a hydroxyl group. The reaction inhibitor is preferably a compound selected from the group consisting of 3-methyl-1-butyne-3-ol, 3,5-dimethyl-1-hexyne-3-ol and phenyl butynol.

### <Residual Adhesion Rate>

The residual adhesion rate as used in the present invention means an index of an amount of the migration component migrated, and may be measured by the method utilizing a difference between peel forces before and after the heat-setting. The residual adhesion rate of the first release film 31 corresponding to a light-peel side film in the present invention as measured using a tape No. 31B produced by Nitto Denko Corp., is 60 to 90%, preferably 65 to 85% and more preferably 70 to 80%. When the residual adhesion rate of the first release film is less than 60%, the amount of the migration component migrated tends to be excessively large, so that the migration component tends to be further migrated to rolls or an adhesive surface upon processing the adhesive, thereby causing deterioration in adhesion peel force. On the other hand, when the residual adhesion rate of the first release film is more than 90%, it is not possible to control the peel speed dependency of the release film to a low level.

### <Peel Force>

In the present invention, the method of controlling a peel force of the release layer can be achieved by selecting a suitable composition in the release layer, though the other methods may also be adopted. More specifically, there may be mentioned the method of varying the kind of releasing agent used in the silicone release layer according to the peel force as desired. Further, since the peel force has a large dependency on a coating amount of the releasing agent used, there may be used the method of controlling a coating amount of the releasing agent used.

The peel force of the first release film 31 corresponding to a light-peel side release film in the present invention is represented by the value as measured using a tensile tester by the following method. That is, a double-sided adhesive tape (“No. 502” and “No. 31B” produced by Nitto Denko Corp.) is attached onto a surface of a release layer of the first release film 31, and after allowing the resulting laminated film to stand at room temperature for 1 hr, the tape is peeled off from the substrate film of the release film using the tensile tester at a peel angle of 180° at an optional elastic stress rate to measure the peel force.

The peel force of the first release film 31 corresponding a light-peel side in the present invention relative to the tape “No. 502” is usually 3 to 50 mN/cm, preferably 5 to 25 mN/cm and more preferably 10 to 20 mN/cm as measured at an elastic stress rate of 300 mm/min. When the peel force of the first release film is less than 3 mN/cm, the release film tends to be easily peeled off, so that even a slight external force generated in the production process tends to cause undesirable peeling of the release film. On the other hand, when the peel force of the first release film is more than 50 mN/cm, there tends to arise such a problem that a clearance in which air bubbles might be entrapped is generated between the second release film and the adhesive layer in the step of peeling the first release film.

The value of the peel force of the first release film 31 corresponding a light-peel side in the present invention relative to the tape “No. 31B” as measured at an elastic stress rate of 300 mm/min (low-speed peel force) is usually in the range of 10 to 20 mN/cm. When the low-speed peel force of the first release film is less than 10 mN/cm, there tends to arise such a problem that undesirable peeling readily occurs owing to such an excessively light peel force even when it is unnecessary to peel the release film. When the low-speed peel force of the first release film is more than 20 mN/cm, the difference between the peel force of the above release film on a light-peel side and that of the release film on a heavy-peel side tends to become small, thereby causing problems during the peeling step, and there also tends to arise such a problem that the range of selection of the heavy-peel side release film is narrowed.

In addition, in the present invention, it is required that the high-speed peel force as measured at an elastic stress rate of 10000 mm/min in view of a good processability is not more than 2.5 times the above low-speed peel force. When the peel force ratio is more than 2.5 times, the difference between the peel force of the light-peel side release film and that of the heavy-peel side release film tends to become small, so that the release film tends to be well peeled off in the peeling step, or there tends to arise such a problem that the release film is peeled off together with the adhesive.

The peel force of the second release film 32 corresponding to a heavy-peel side release film in the present invention is represented by the value as measured using a tensile tester by the following method. That is, a double-sided adhesive tape (“No. 502” produced by Nitto Denko Corp.) is attached onto a surface of a release layer of the second release film 32, and after allowing the resulting laminated film to stand at room temperature for 1 hr, the tape is peeled off from the substrate film of the release film using the tensile tester at a peel angle of 180° at an optional elastic stress rate to measure the peel force. In the present invention, as the method of controlling a peel force of the release layer, there may be adopted the method of selecting a suitable composition in the release layer, or the other methods. More specifically, there is preferably used the method of varying the kind of releasing agent used in the silicone release layer according to the peel force as desired. Further, since the peel force has a large dependency on a coating amount of the releasing agent used, there is also preferably used the method of controlling a coating amount of the releasing agent used.

The peel force of the second release film 32 corresponding to a heavy-peel side release film relative to the tape “No. 502” is usually 20 to 100 mN/cm, and preferably 30 to 60 mN/cm as measured at an elastic stress rate of 300 mm/min. When the peel force of the second release film is less than 20 mN/cm, a part of the second release film tends to be undesirably peeled off when the first release film is peeled off. On the other hand, when the peel force of the second release film is more than 100 mN/cm, there tends to arise such a problem that the adhesive remains attached onto the second release film when peeled, etc.

In the substrateless double-sided adhesive sheet 10 according to the present invention, in addition to the above requirement concerning the peel force, it is preferred to provide a peel ratio between the first release film and the second release film.

The peel force of the second release film 32 relative to the tape No. 502 is usually not less than 2.0 times, preferably not less than 2.5 times and more preferably not less than 3.0 times the peel force of the first release film 31 relative to the tape No. 502. When the peel force of the second release film 32 relative to the tape No. 502 is less than 2.0 times the peel force of the first release film 31 relative to the tape No. 502, in the case where the light-peel side first release film 31 is peeled off from the adhesive layer 11 after producing the substrateless double-sided adhesive sheet 10, there tends to occur such a phenomenon that the second release film 32 is floated from the adhesive layer 11, the adhesive tends to remain attached onto the second release film 32, or there tends to occur so-called zipping upon the peeling. The above floating phenomenon means such a phenomenon in which the peel force of the release film upon the peeling is weak, and therefore a part of the adhesive layer is peeled off so that air, etc., are entrapped therein, resulting a poor appearance of the release film.

In addition, the peel force of the first release film 31 corresponding to a light-peel side release film in the present invention relative to the adhesive layer 11 is 3 to 50 mN/cm and preferably 5 to 25 mN/cm. When the peel force of the first release film is less than 3 mN/cm, the release film tends to be easily peeled off, so that even a slight external force generated in the production process tends to cause undesirable peeling of the release film. On the other hand, when the peel force of the first release film is more than 50 mN/cm, there tends to arise such a problem that peeling called floating is generated between the second release film and the adhesive layer in the step of peeling the first release film.

When the peel force of the first release film 31 relative to the adhesive layer 11 is controlled to a low level, even if the peel force of the second release film 32 is reduced, it is possible to increase the peel force ratio between both the release films 31 and 32.

Also, when the peel force of the first release film 31 relative to the adhesive layer 11 is controlled to a predetermined value or more, it is possible to prevent unexpected peeling of the first release film 31 from the adhesive layer 11 before use, or cause floating of the first release film 31 from the adhesive layer 11.

The peel force of the second release film 32 corresponding to a heavy-peel side release film relative to the adhesive layer 11 is preferably 20 to 100 mN/cm and more preferably 30 to 60 mN/cm. When the peel force of the second release film is less than 20 mN/cm, a part of the second release film tends to be undesirably peeled off when peeling the first release film. On the other hand, when the peel force of the second release film is more than 100 mN/cm, there tends to arise such a problem that the adhesive undesirably remains attached onto the second release film.

### <Martens' Hardness>

The Martens' hardness of the surface of the release layer is also an important factor in order to achieve improvement in peel speed dependency of the first release film 31 corresponding to a light-peel side release film in the present invention.

The Martens' hardness means the value obtained by subjecting a surface layer of the release film to instrumented indentation hardness test using a hardness tester with a triangular pyramid indenter under the conditions of an optional testing force, an optional loading rate, and an optional loading and unloading retention time.

The Martens' hardness of the first release film 31 corresponding to a light-peel side release film in the present invention is not less than 400 N/mm². When the Martens' hardness of the first release film is less than 400 N/mm², the hardness of the first release film tends to fail to match with the hardness of the adhesive layer 11, so that the peel speed dependency tends to be increased, and undesirable phenomenon such as zipping tends to be caused, resulting in poor productivity. In addition, the silicone-based release layer tends to suffer from scratches, etc., owing to softness thereof, so that OL tends to be generated, and therefore there tend to arise such a problem that process contamination and adhesive contamination are induced, or the like.

### <OL Sealing Layer>

Of the release films, at least the first release film 31 comprises a biaxially oriented polyester film 13 and a release layer 15 which are laminated in this order. In order to prevent contamination of the production process, it is preferable to provide a coating layer 14 as an OL sealing layer. In this case, the biaxially oriented polyester film 13, the coating layer 14 and the release layer 15 are laminated on each other in this order.

In the present invention, provision of the OL sealing layer (first coating layer 14) in the first release film 31 and the OL sealing layer (second coating layer 24) in the second release film 32 is desirable to prevent contamination of the process owing to OL and contamination of the adhesive layer 11 or the other substrates to which the film is attached.

In the present invention, in the case where the first release film 31 comprises the first coating layer 14 and further the second release film 32 comprises the second coating layer 24, the amount of OL extracted from the surface of the coating layer (A) with dimethyl formamide after subjecting these release films to heat treatment (at 180° C. for 10 min) is preferably not more than 1.0 mg/m². When the amount of OL extracted is more than 1.0 mg/m², contamination of the process tends to occur, and there tends to arise the problems such as generation of foreign matters upon adhesive lamination and deterioration in yield of products.

Of the release films, at least the second release film 32 comprises a biaxially oriented polyester film 23 and a release layer 25 which are laminated in this order. In order to prevent contamination of the production process, it is preferable to provide a coating layer 24 as an OL sealing layer. In this case, the biaxially oriented polyester film 23, the coating layer 24 and the release layer 25 are laminated on each other in this order.

In the case where neither coating layer 14 nor coating layer 24 is formed, OL tends to be generated during the production process of the substrateless double-sided adhesive sheet.

### <MOR_C Value>

In the second release film 32 on the heavy-peel side of the present invention, when forming the substrateless double-sided adhesive sheet 11 and then peeling the light-peel side release film 31 therefrom to attach the sheet to a separate substrate, it may be sometimes required according to the applications of the sheet that the second release film 32 on the heavy-peel side is subjected to optical inspection in the process.

In the second release film 32 of the present invention, in order to reduce foreign matters or occurrence of light interference color in the optical inspection, etc., it is very important to optimize an MOR_C value obtained by measuring the release film using a microwave-type molecular orientation meter.

The MOR_C value of the second release film 32 of the present invention is 1.5 to 3.0, preferably 1.8 to 2.7 and more preferably 2.1 to 2.4. When the MOR_C value of the second release film is more than 3.0, the release layer tends to be deteriorated in uniformity, or there tend to arise the problems such as likelihood of observation of light interference color in the optical inspection. When the MOR_C value of the second release film is less than 1.5, there tend to arise the problems such as deterioration in yield of the release film itself.

As the method of satisfying the MOR_C value of the second release film 32 of the present invention, there may be mentioned the method of controlling the drawing conditions of the release film so as to attain a desired film thickness upon formation of the film.

### <Adhesive>

As the adhesive forming the adhesive layer 11, there may be usually used acrylic adhesives. The acrylic adhesives comprises, as a main component, an acrylic copolymer obtained by copolymerizing a functional group-containing monomer with the other monomer such as an acrylic acid ester and a methacrylic acid ester, and may also comprise a solvent, a crosslinking agent, a tackifier, a filler, a colorant, an antioxidant, an antistatic agent, an ultraviolet absorber and the like, if required.

Examples of the functional group-containing monomer include carboxyl group-containing monomers such as acrylic acid and methacrylic acid. The content of the functional group-containing monomer in the acrylic copolymer is preferably 0.3 to 5.0 mass % in terms of monomer units based on whole monomers (100 mass %) constituting the acrylic copolymer.

The acrylic copolymer is capable of controlling a cohesive force of the adhesive by the reaction with a crosslinking agent owing to inclusion of the functional group therein, and not only can suppress squeeze-out of the adhesive from the substrate but also can improve an adhesion property and a heat resistance of the adhesive. The crosslinking agent used in the adhesive is not particularly limited, and may be appropriately selected from conventionally known crosslinking agents generally used for acrylic adhesives. Specific examples of the crosslinking agent include polyisocyanate compounds, epoxy resins, melamine resins, urea resins, dialdehydes, methylol polymers, aziridine-based compounds, metal chelate compounds, metal alkoxides and metal salts. Of these crosslinking agents, the polyisocyanate compounds can be suitably used.

### <Thickness of Release Film>

The thickness of the release film is not particularly limited as long as the thickness is in the range capable of forming a film shape and can be processed as that of a release film, and is usually in the range of 10 to 300 μm, preferably 30 to 188 μm, and more preferably 50 to 75 μm. When the thickness of the release film is less than 10 μm, the resulting film tends to lack a nerve, or foreign matters present in the process tend to be transferred to the film, or there tend to arise troubles upon peeling the release film. When the thickness of the release film is more than 300 μm, there tens to occur deterioration in productivity upon formation of the film or processing, thereby causing increase in costs.

In the present invention, the substrateless double-sided adhesive sheet 10 is preferably provided on both sides thereof with release films that are different in thickness from each other. More specifically, the thickness of the second release film is usually not less than 1.2 times, and preferably not less than 1.4 times the thickness of the first release film. When the thickness of the first release film on the light-peel side is smaller than that of the second release film, it is possible to prevent occurrence of floating on a boundary between the second release film and the adhesive layer when peeling the first release film.

In addition, in the case where an adhesive is applied onto a releasing surface of the second release film, in order to reduce adverse influence of foreign matters or irregularities in the process, the thickness of the second release film that is more likely to be adversely affected by the irregularities or foreign matters is preferably increased in view of production costs.

When the thickness of the second release film is less than 1.2 times the thickness of the first release film, such a construction tends to have a less contribution to costs.

### <Substrateless Double-Sided Adhesive Sheet>

The substrateless double-sided adhesive sheet 10 may be produced, for example, by applying an adhesive on the second release layer 25 of the second release film 32, followed by drying the thus applied adhesive to form the adhesive layer 11, and then laminating the first release film 31 on the release layer 11. However, in the case where no coating layer 24 is provided, there tend to arise the problems including not only contamination of the process owing OL generated the production step, but also failure of electronic parts by adverse influence of OL when laminating the adhesive layer on a substrate of the electronic parts.

In addition, in the substrateless double-sided adhesive sheet 10, in the case where the adhesive layer 11 is formed on the first release layer 15 of the first release film 31, if no coating layer 14 is provided in the first release film 31, there tends to occur the same undesirable phenomenon as observed in the second release film 32.

### EXAMPLES

The present invention is described in more detail below by Examples. However, these Examples are only illustrative and not intended to limit the present invention thereto, and various changes or modifications are possible and intended to fall within the scope of the present invention unless they depart from the subject matters thereof. The measuring methods and the evaluation method used in the present invention are as follows.

### (1) Measurement of Intrinsic Viscosity of Polyester:

One gram of a polyester from which the other polymers incompatible with polyester and pigments had been removed was accurately weighed, and mixed with and dissolved in 100 mL of a mixed solvent comprising phenol and tetrachloroethane at a weight ratio of 50/50, and a viscosity of the resulting solution was measured at 30° C.

(2) Measurement of Average Particle Diameter (d50; μm):

Using a centrifugal precipitation type particle size distribution measuring apparatus “SA-CP3 Model” manufactured by Shimadzu Corp., the particle size corresponding to a cumulative fraction of 50% (on a weight basis) in equivalent spherical distribution of the particles was measured as an average particle diameter.

### (3) Measurement of Amount of Catalyst in Coating Layer:

Using SAICAS, the sample film was cut obliquely to expose a section thereof. Thereafter, the content of catalysts including platinum in the coating layer of the polyester film was determined using TOF-SIMS (time-of-flight secondary ion mass spectrometer).

### (4) Measurement of Amount of Migration Component in Composition of Release Layer:

Added to 15 g of a silicone resin (silicone in a release layer composition) diluted to a solid concentration of 4% by weight with toluene was 0.004 g of a 0.02 wt. % platinum catalyst, and after stirring, the resulting mixture was placed in a box prepared, from a Teflon (registered trademark) sheet, and heat-cured at 150° C. for 1 hr (sample 1). In the case where the migration component was added (corresponding to the below-mentioned Comparative Example 2), the migration component was added in an amount of 30% by weight based on a solid content of the silicone resin. The sample 1 was immersed in toluene for one day, and thereafter taken out from toluene, dried at 120° C. for 30 min, and allowed to stand for cooling until reaching room temperature (sample 2). The amount of the migration component was calculated from the following formula.

Amount of migration component (% by weight)=(weight of sample 1-weight of sample 2) weight of sample 1×100

### (5) Adhesion Rate for Evaluating Migration Property of Release Film: Residual Adhesion Rate:

The sample film was cut into an A4 size, and a 75 μm-thick biaxially oriented PET film (“DIAFOIL T100-75” produced by Mitsubishi Chemical Polyester Film Corp.) was laminated on a releasing surface of the cut film and pressed at 60° C. under 1 MPa for 2 hr. The 75 μm-thick film pressed on the releasing surface of the film was used as a film for evaluating a migration property of the film. The same kind of 75 μm-thick biaxially oriented PET film was also pressed on an untreated PET film to prepare a reference film. After attaching an adhesive tape (“No. 31B” produced by Nitto Denko Co., Ltd.) onto a pressed surface of the respective films, the films were cut into a size of 50 mm×300 mm, and allowed to stand at room temperature for 1 hr and then measured for a peel force of the tape. The peel force was measured by subjecting the film to 180° peel test at an elastic stress rate of 0.3 (m/min) using “Ezgraph” manufactured by Shimadzu Corp.

Residual adhesion rate (%)=(peel force of film for evaluation of migration property÷peel force of reference film)×100

In the case of the film having a high migration property, a large amount of silicone was deposited on the film pressed. Therefore, the peel force of the adhesive tape from such a film became small, and the adhesion rate (%) for evaluation of the migration property was also lowered.

### (6) Evaluation of Peel Force of Release Film Using No. 502 Tape:

After attaching one surface of a double-coated adhesive tape (“No. 502” and “No. 31B” produced by Nitto Denko Co., Ltd.) onto a surface of a release layer of a sample film, the resulting laminated film was cut into a size of 50 mm×300 mm and allowed to stand at room temperature for 1 hr, and then subjected to measurement of a peel force thereof. The peel force of the film was measured using a tensile tester “INTESCO MODEL 2001 TYPE” manufactured by Intesco Co., Ltd., by subjecting the film to 180° peel test at an elastic stress rate of 300 mm/min. The peel force was evaluated according to the following evaluation ratings.

### (7) Evaluation of Peel Force of Release Film Using No. 31B

After attaching one surface of a double-coated adhesive tape (“No. 31B” produced by Nitto Denko Co., Ltd.) onto a surface of a release layer of a sample film, the resulting laminated film was cut into a size of 50 mm×300 mm and allowed to stand at room temperature for 1 hr, and then subjected to measurement of a peel force thereof. The peel force of the film was measured using a tensile tester “INTESCO MODEL 2001 TYPE” manufactured by Intesco Co., Ltd., by subjecting the film to 180° peel test at an elastic stress rate of 300 mm/min and further at 10000 mm/min. The peel force was evaluated according to the following evaluation ratings.

<Peel Force at 300 mm/min>

A: Falling within the range of 10 to 20 mN/cm; and

B: Less than 10 mN/cm, or more than 20 mN/cm.

<Comparison Between Peel Force at 10000 mm/min and Peel Force at 300 mm/min>

Determined from the value calculated from the following formula.

(Peel force at 10000 mm/min (mN/cm))÷(Peel force at 300 mm/min (mN/cm))

A: Not more than 2.5:

B: More than 2.5.

### (8) Martens' Hardness of Surface Layer:

The surface layer of the polyester film was subjected to indentation test using a dynamic super-micro-hardness tester (“DUH-211”) manufactured by Shimadzu Corp., with a triangular pyramid indenter (apex angle: 115°; Berkovich type), under the conditions of a testing force of 0.1 mN, a load holding rate of 0.0060 mN/sec, and a load holding time of 2 sec. The Martens' hardness of the surface layer of the polyester film was calculated from a depth of indentation by the above testing force. Meanwhile, the measurement was carried out twelve times to obtain an average value thereof.

(9) Measurement of OL Extracted from Surface of Anchor

An untreated release film was previously heated in air at 180° C. for 10 min. Thereafter, the thus heat-treated film was possibly closely attached to an inner wall surface of an open-topped box having a size of 10 cm in length×10 cm in width×3 cm in height and thereby folded into a box shape. If the release film had a coating layer, the film was disposed such that a surface of the coating layer faced to an inside of the box. Next, 4 mL of DMF (dimethyl formamide) was charged in the thus formed box and allowed to stand therein for 3 min, and then recovered. The thus recovered DMF was fed to a liquid chromatograph “LC-7A” manufactured by Shimadzu Corp., to measure an amount of OL in DMF. The thus measured amount of OL was divided by an area of the film contacted with DMF to calculate an amount (mg/m²) of OL on the surface of the film.

The amount of OL in DMF was determined from a peak area ratio between a peak area of a control sample and a peak area of a sample to be measured (absolute calibration method). The control sample was prepared by accurately weighing a previously sampled OL (cyclic trimer) and dissolving the OL in DMF accurately weighed. The concentration of the control sample is preferably in the range of 0.001 to 0.01 mg/mL. Meanwhile, the conditions of the liquid chromatograph used were as follows.

Mobile phase A: Acetonitrile

Mobile phase B: 2% Acetic acid aqueous solution

Column: “MCI GEL ODS 1HU” manufactured by Mitsubishi Chemical Corp.

Column temperature: 40° C.

Flow rate: 1 mL/min

Detection wavelength: 254 nm

### (10) Measurement of MOR_C Value of Polyester Film Using Microwave Molecular Orientation Meter:

Using a microwave-type molecular orientation meter produced by Oji Scientific Instruments, the MOR_C value of the polyester film was determined from a transmission microwave intensity pattern thereof.

### (11) Measurement of MOR_C Value of Polyester Film Using Microwave Molecular Orientation Meter:

Using a microwave-type molecular orientation meter produced by Oji Scientific Instruments, the MOR_C value of the polyester film was determined from a transmission microwave intensity pattern thereof, and evaluated according to the following evaluation ratings.

A: 2.0 to 2.5;

B: 1.5 to 1.9 or 2.6 to 3.0; and

C: Less than 1.5%, or more than 3.0.

### (12) Practicability

### <Degree of Process Contamination Upon Processing>

Rolls, etc., used in the process were visually observed to inspect a degree of contamination thereof by adhesive as well as foreign matters, OL and migration component from the release film upon the laminating process.

### “Evaluation Ratings”

A: Substantially no contamination was recognized even when traveling not less than 6000 m;

B: Rolls, etc., were stained whitely and therefore contamination thereof was recognized when travelling 1000 to 6000 m; and

C: Rolls, etc., were stained whitely and therefore contamination thereof was recognized when travelling not more than 1000 m.

(Ranks A and B are acceptable without problems upon practical use.)

### <Condition of Occurrence of Zipping>

Upon measuring the peel force, the peeling condition between the adhesive and the release film was observed to evaluate occurrence of zipping according to the following three evaluation ratings.

A: Extremely smoothly peeled without peel lines or peel sound;

B: Slight peel lines and slight peel sound occurred, as well as slight zipping occurred; and

C: Peel lines and peel sound occurred, as well as zipping occurred.

(Ranks A and B are acceptable without problems upon practical use.)

### <Visual Inspection Property Under Reflected Light: Visual Inspection Property>

In view of inspection of a polarizing plate, the film coated with a release agent was dried at a dryer temperature of 120° C. and taken up at a line speed of 30 m/min to obtain a release film. The thus obtained release film was closely adhered to a polarizing film through an adhesive such that the width direction of the release film was parallel with an orientation axis of the polarizing film to thereby obtain a polarizing plate. The thus obtained polarizing plate was visually observed under a reflected light from a fluorescent lamp, and the visual inspection property thereof under reflected light was evaluated according to the following evaluation ratings. Meanwhile, upon the measurement, the sample with A4 size was cut from the film, and the thus cut sample was used for the evaluation.

### [Evaluation Ratings]

A: Good inspection property was attained;

B: Inspection was conducted substantially without problems; and

C: Inspection property was poor.

(Ranks A and B are acceptable without problems upon practical use.)

### <Visual Inspection Property Under Crossed-Nicol: Polarization Inspection Property>

In view of inspection of a polarizing plate, the film coated with a release agent was dried at a dryer temperature of 120° C. and taken up at a line speed of 30 m/min to obtain a release film. The thus obtained release film was closely adhered to a polarizing film through an adhesive such that the width direction of the release film was parallel with an orientation axis of the polarizing film to thereby obtain a polarizing plate. Upon forming the polarizing plate, black metal particles having a size of not less than 50 μm (foreign matters) were included between the adhesive and the polarizing film in an amount of 50 particles/m². On the release film of the thus obtained polarizing plate in which the foreign matters were included, another polarizing plate for inspection was overlapped such that the width direction of the release film was perpendicular to an orientation axis of the polarizing plate for inspection. White light was irradiated from the side of the former polarizing plate and visually observed on the side of the polarizing plate for inspection, and whether or not the foreign matters included between the adhesive and the polarizing film were detected under Crossed-Nicol was examined and evaluated according to the following evaluation ratings. Meanwhile, upon the measurement, the samples with A4 size were cut from three portions of the resulting film, i.e., a central portion and both end portions of the film along the width direction thereof, and the thus cut three samples were used for the evaluation.

### [Evaluation Ratings]

A: Foreign matters were well recognized.

B: Foreign matters were recognized with comparatively less problems.

C: Foreign matters were poorly recognized.

(Ranks A and B are acceptable without problems upon practical use.)

### (13) Total Evaluation:

The film was evaluated in view of all of properties including a film-forming property, productivity, inspection property, etc., according to the following evaluation ratings.

A: Products produced were sufficiently supplied as good products;

B: Good productivity, and a less frequency of defects in optical inspection; and

C: Poor productivity, and many defects were caused in optical inspection.

The polyesters used in Examples and Comparative Examples were prepared as follows.

<Method for Producing Polyester (a)>

One hundred parts by weight of dimethyl terephthalate and 60 parts by weight of ethylene glycol as starting materials were charged together with tetrabutoxy titanate as a catalyst into a reactor, and the reaction therebetween was initiated at 150° C. The reaction temperature was gradually raised while distilling off methanol produced, and allowed to reach 230° C. after 3 hr. After 4 hr, the transesterification reaction was substantially terminated, followed by subjecting the resulting reaction solution to polycondensation reaction for 4 hr. More specifically, the reaction temperature was gradually raised from 230° C. until reaching 280° C. On the other hand, the reaction pressure was gradually reduced from normal pressure until finally reaching 0.3 mmHg. After initiation of the reaction, an agitation power in the reaction vessel was monitored, and the reaction was terminated at the time at which a viscosity of the reaction solution reached the value corresponding to an intrinsic viscosity of 0.61, which was determined by the change in agitation power in the reaction vessel. The resulting polymer was discharged under application of a nitrogen pressure from the reaction vessel, thereby obtaining a polyester (a) having an intrinsic viscosity of 0.61.

<Method for Producing Polyester (b)>

The same procedure as defined in the above production of the polyester (a) was conducted except that after adding ethyl acid phosphate, an ethylene glycol slurry of synthetic calcium carbonate particles having an average particle diameter of 0.8 μm was added to the resulting mixture such that the content of the synthetic calcium carbonate particles based on the polyester was 1% by weight, thereby obtaining a polyester (b). As a result, it was confirmed that the thus obtained polyester (b) had an intrinsic viscosity of 0.60.

<Production of Polyester (c)>

One hundred parts by weight of dimethyl terephthalate and 60 parts by weight of ethylene glycol as starting materials were charged together with magnesium acetate tetrahydrate as a catalyst into a reactor, and the reaction therebetween was initiated at 150° C. The reaction temperature was gradually raised while distilling off methanol produced, and allowed to reach 230° C. after 3 hr. After 4 hr, the transesterification reaction was substantially terminated. The obtained reaction mixture was mixed with ethyl acid phosphate and then transferred to a polycondensation reaction vessel. Further, the reaction mixture thus transferred was mixed with 0.04 part of antimony trioxide, followed by subjecting the mixture to polycondensation reaction for 4 hr. More specifically, the reaction temperature was gradually raised from 230° C. until reaching 280° C. On the other hand, the reaction pressure was gradually reduced from normal pressure until finally reaching 0.3 mmHg. After initiation of the reaction, an agitation power in the reaction vessel was monitored, and the reaction was terminated at the time at which a viscosity of the reaction solution reached the value corresponding to an intrinsic viscosity of 0.45, which was determined by the change in agitation power in the reaction vessel. The resulting polymer was discharged under application of a nitrogen pressure from the reaction vessel, thereby obtaining chips of a polyester (c). As a result, it was confirmed that the thus obtained polyester (c) had an intrinsic viscosity of 0.45.

<Production of Polyester (d)>

The polyester chips were subjected to solid state polycondensation reaction to increase an intrinsic viscosity thereof. Specifically, the polyester chips were treated in a pre-crystallization vessel in a nitrogen atmosphere at 170° C. for 0.5 hr, and then dried using a tower-type drying device through which an inert gas was flowed, such that a water content in the polyester chips was 0.005% a measured at 200° C. Thereafter, the polyester chips were transferred to a solid state polycondensation vessel and subjected to solid state polycondensation at 240° C. for 3 hr, thereby obtaining a polyester (d) having an intrinsic viscosity of 0.70.

<Production of Polyester (e)>

When producing the polyester (d), the solid state polycondensation was conducted in the solid state polycondensation vessel for 5 hr, thereby obtaining a polyester (e) having an intrinsic viscosity of 0.80.

### Example 1

### Production of Polyester Film

A mixture obtained by mixing 70% by weight of the polyester (e) and 30% by weight of the polyester (b) as an raw material for surface layers, and a mixture obtained by mixing 84% by weight of the polyester (a) and 16% by weight of the polyester (b) as an raw material for an intermediate layer, were respectively charged into two vented extruders, and melted therein and extruded at 290° C. therefrom, and then cooled and solidified on a chilled roll whose surface was controlled to a temperature of 40° C., by an electrostatic pinning method, thereby obtaining an undrawn sheet. Next, the thus obtained undrawn sheet was drawn at 100° C. at a draw ratio of 3.0 times in a longitudinal direction thereof, and then the following coating material was applied onto one surface of the thus longitudinally drawn film such that a coating amount of the coating material (after dried) was 0.03 g/m². The thus coated longitudinally drawn film was introduced into a tenter in which the film was preheated and then drawn at 120° C. at a draw ratio of 4.3 times in a lateral direction thereof. Then, the obtained drawn sheet was subjected to heat-setting at 220° C. for 10 sec, and then relaxed by 4% in a width direction thereof at 180° C., thereby obtaining a master roll having a width of 4000 mm. The thus obtained master roll was slit at the position spaced 1400 mm from the end of the master roll, and a sheet having a length of 1000 m was taken up on a core, thereby obtaining a polyester film. As a result, it was confirmed that the thus obtained polyester film had a total thickness of 50 μm (layer structure: surface layer 2.5 μm/intermediate layer 45 μm/surface layer 2.5 μm). However, in the present invention, merely in the case where the coating layer aiming at attaining an OL sealing property (corresponding to 14, 24 in FIG. 1) is provided, the polyester film may be drawn in a lateral direction thereof while conducting the coating step after drawn in a longitudinal direction thereof.

### <Coating Layer>

The examples of the compounds constituting the coating layers 14 and 15 are as follows.

### (Examples of Compounds)

Binder polymer A: Polyvinyl alcohol having a saponification degree of 88 mol % and a polymerization degree of 350
Binder polymer B: Emulsion polymer (emulsifier: anionic surfactant) produced from methyl methacrylate/ethyl acrylate/acrylonitrile/N-methylol methacrylamide=45/45/5/5 (molar ratio)
Crosslinking agent C: Hexamethoxy melamine crosslinking agent
Particles D: Colloidal silica (average particle diameter: 70 nm)

Compounding ratio in terms of a solid content: A/B/C/D=30/24/42/4

With respect to the light-peel sheet 31 and the heavy-peel sheet 32, the drawing method and the thickness of the respective films were changed variously (refer to Table 1).

The resulting polyester films for the light-peel sheet 31 and the heavy-peel sheet 32 were coated with the following respective releasing agents in a coating amount (after dried) of 0.1 g/m² by a reverse gravure coating method, dried at a dryer temperature of 120° C., and then taken up into a roll at a line speed of 30 m/min, thereby obtaining a roll-shaped release polyester film.

### <Release Layer>

The respective coating materials having the following release layer compositions were applied onto a biaxially oriented polyester film produced according to the aforementioned production of the polyester film in a coating amount (after dried) of 0.1 g/m², thereby obtaining a release film.

Release Layer Composition-1:

| | |
|---|---|
| Curing-type silicone resin (“LTC303E” produced by Dow | 20 parts |
| Corning Toray Co., Ltd.) | |
| Addition-type platinum catalyst (“SRX212” produced by | 0.2 part |
| Dow Corning Toray Co., Ltd.) | |
| Mixed solvent of MEK/toluene/n-heptane (mixing ratio of | |
| 1:1:1) | |
| Amount of migration component in release layer | 15% by weight |
| composition-1: | |

Release Layer Composition-2:

| | |
|---|---|
| Curing-type silicone resin (“KS-847H” produced by Shin- | 20 parts |
| Etsu Chemical Co., Ltd.) | |
| Addition-type platinum catalyst (“PL-50T” produced by | 0.2 part |
| Shin-Etsu Chemical Co., Ltd.) | |
| Mixed solvent of MEK/toluene/n-heptane (mixing ratio of | |
| 1:1:1) | |
| Amount of migration component in release layer | 5% by weight |
| composition-2: | |

Release Layer Composition-3:

| | |
|---|---|
| Curing-type silicone resin (“LTC303E” produced by Dow | 20 parts |
| Corning Toray Co., Ltd.) | |
| Silicone oil (“KS-64-100cs”) | 0.18 part |
| Addition-type platinum catalyst (“SRX212” produced by | 0.2 part |
| Dow Corning Toray Co., Ltd.) | |
| Mixed solvent of MEK/toluene/n-heptane (mixing ratio of | |
| 1:1:1) | |
| Amount of migration component in release layer | 23% by weight |
| composition-3: | |

Release Layer Composition-4:

| Curing-type silicone resin (“X-62-5039” produced by | 14 parts |
|---|---|
| Shin-Etsu Chemical Co., Ltd.) | |
| Peel controlling agent (“KS-3800” produced by Shin-Etsu | 6.0 parts |
| Chemical Co., Ltd.) | |
| Crosslinking agent (“X-92-185” produced by Shin-Etsu | 0.4 part |
| Chemical Co., Ltd.) | |
| Catalyst (“PL-5000” produced by Shin-Etsu Chemical Co., | 1.0 part |
| Ltd.) | |
| Mixed solvent of MEK/toluene/n-heptane (mixing ratio of | |
| 1:1:1) | |

Release Layer Composition-5:

| Curing-type silicone resin (“X-62-5039” produced by | 12 parts |
|---|---|
| Shin-Etsu Chemical Co., Ltd.) | |
| Peel controlling agent (“KS-3800” produced by Shin-Etsu | 8.0 parts |
| Chemical Co., Ltd.) | |
| Crosslinking agent (“X-92-185” produced by Shin-Etsu | 0.4 part |
| Chemical Co., Ltd.) | |
| Catalyst (“PL-5000” produced by Shin-Etsu Chemical Co., | 1.0 part |
| Ltd.) | |
| Mixed solvent of MEK/toluene/n-heptane (mixing ratio of | |
| 1:1:1) | |

Release Layer Composition-6:

| | |
|---|---|
| Curing-type silicone resin (“KS-847H” produced by Shin- | 20 parts |
| Etsu Chemical Co., Ltd.) | |
| Addition-type platinum catalyst (“PL-50T” produced by | 0.2 part |
| Shin-Etsu Chemical Co., Ltd.) | |
| Silicone oil (“KS-64-100cs”) | 0.04 part |
| Mixed solvent of MEK/toluene/n-heptane (mixing ratio of | |
| 1:1:1) | |
| Amount of migration component in release layer | 6% by weight |
| composition-6: | |

Release Layer Composition-7:

| | |
|---|---|
| Curing-type silicone resin (“LTC303E” produced by Dow | 20 parts |
| Corning Toray Co., Ltd.) | |
| Silicone oil (“KS-64-100cs”) | 0.09 part |
| Addition-type platinum catalyst (“SRX212” produced by | 0.2 part |
| Dow Corning Toray Co., Ltd.) | |
| Mixed solvent of MEK/toluene/n-heptane (mixing ratio of | |
| 1:1:1) | |
| Amount of migration component in release layer | 23% by weight |
| composition-7: | |

<Production of Polarizing Plate with Release Film>

The resulting release film was tested using a polarizing plate to confirm an inspection property for optical characteristics thereof. The following acrylic adhesive was applied onto the polarizing plate such that a thickness of a coating layer obtained after drying the acrylic adhesive applied was 25 μm. The thus coated polarizing plate was passed through a drying oven at 130° C. for 30 sec, and then a release film was laminated thereon to thereby prepare the polarizing plate with the release film in which the release film was adhered to the polarizing film through the adhesive. The lamination of these films was conducted such that the width direction of the release film was parallel with an orientation axis of the polarizing film.

Acrylic Adhesive Coating Solution:

| | |
|---|---|
| Acrylic adhesive (“ORIBAIN BPS429-4” produced by Toyo Ink | 100 parts |
| Co., Ltd.) | |
| Curing agent (“BPS8515” produced by Toyo Ink Co., Ltd.) | 3 parts |
| Mixed solvent of MEK/toluene (mixing ratio: 1:1) | 50 parts |

### <Production of Substrateless Double-Sided Adhesive Sheet>

The acrylic adhesive coating solution was applied onto the release layer of the thus obtained second release film using an applicator such that the thickness of the resulting coating layer after dried was 25 μm, and then the coating layer was dried at 120° C. for 1 min, thereby obtaining an adhesive layer. The acrylic adhesive coating solution was prepared by adding 1 part by mass of a polyisocyanate-based crosslinking agent (“BHS8515” (tradename) produced by Toyo Ink Co., Ltd.) to 100 parts by mass of a copolymer solution comprising butyl acrylate and acrylic acid at a mass ratio of 99:1 based on these monomers (solvent: toluene; solid content: 40% by mass) and mixing the resulting mixture. Next, the release layer of the first release film was laminated onto the adhesive layer, thereby obtaining a substrateless double-sided adhesive sheet of Example 1. The results are shown in Table 1.

### Examples 2 to 4

The same procedure as in Example 1 was conducted except that the draw ratio, the film thickness and provision or non-provision of the coating layer upon production of the polyester film were changed, or the silicone composition used upon forming the silicone layer on the polyester film as well as the thickness of the coating layer were changed, thereby obtaining polyester films. The results are collectively shown in Table 1 below

### Comparative Examples 1 to 4

The same procedure as in Example 1 was conducted except that the draw ratio, the film thickness and provision or non-provision of the coating layer upon production of the polyester film were changed, or the silicone composition used upon forming the silicone layer on the polyester film as well as the thickness of the coating layer were changed, thereby obtaining polyester films. The results are collectively shown in Table 2 below

TABLE 1

| Examples | (Unit) | 1 | 2 | 3 | 4 |
|---|---|---|---|---|---|
| First release film | | | | | |
| Film thickness | (μm) | 50 (2.5/45/2.5) | | | |
| Coating amount of | (g/m²) | 0.03 | 0 | | |
| component of coating | | | | | |
| layer 14 | | | | | |
| Composition of silicone- | (−) | 1 | 7 | 1 | |
| based release layer 15 | | | | | |
| Coating amount of | (g/m²) | 0.12 | 0.15 | 0.20 | 0.08 |
| silicone-based release | | | | | |
| layer 15 (after dried) | | | | | |
| Amount of migration | (wt. %) | 15 | 19 | 15 | 15 |
| component in release | | | | | |
| agent composition | | | | | |
| 502 Tape: | | | | | |
| Peel force of release film | (mN/cm) | 18 | 17 | 14 | 18 |
| 31B Tape | | | | | |
| Peel force of release film | (mN/cm) | 14 | 16 | 11 | 18 |
| at 300 mm/min | | A | A | A | A |
| Peel force of release film | (mN/cm) | 32 | 36 | 27 | 36 |
| at 10000 mm/min | | | | | |
| Ratio between peel forces | (−) | 2.3 | 2.4 | 2.4 | 2.0 |
| at 300 mm/min and 10000 | | A | A | A | A |
| mm/min | | | | | |
| Residual adhesion rate | (%) | 75 | 61 | 70 | 89 |
| Martens' hardness of | (N/mm²) | 440 | 455 | 520 | 401 |
| surface layer | | C | B | A | C |
| Contamination of rolls | (−) | C | B | A | C |
| upon processing (amount | | | | | |
| of OL generated) | | | | | |
| Amount of OL in film | (mg/m²) | 0.88 | 3.26 | 3.26 | 3.26 |
| Peel characteristic relative | (−) | A | B | A | A |
| to adhesive | | | | | |
| Second release film | | | | | |
| Longitudinal draw ratio | (times) | 2.8 | 3.0 | 3.0 | 3.0 |
| Lateral draw ratio | (times) | 5.1 | 4.3 | 4.3 | 4.3 |
| Film thickness | (μm) | 75 (3.75/67.5/3.75 | | | |
| Coating amount of | (g/m²) | 0.03 | 0 | | |
| component of coating | | | | | |
| layer 24 | | | | | |
| Composition of silicone- | (−) | 5 | 4 | | |
| based release layer 25 | | | | | |
| Coating amount of | (g/m²) | 0.12 | | | |
| silicone-based release | | | | | |
| layer 25 (after dried) | | | | | |
| 502 Tape: | | | | | |
| Peel force of release film | (mN/cm) | 66 | 60 | 67 | 61 |
| Amount of OL in film | (mg/m²) | 0.93 | 3.33 | 3.30 | 3.31 |
| MOR_C value | (−) | 2.1 | 2.1 | 2.1 | 2.1 |
| | | A | A | A | A |
| Thickness Ratio of second | (−) | 1.5 | 1.5 | 1.5 | 1.5 |
| release film/first release | | | | | |
| film | | | | | |
| Degree of process | (−) | A | X | B | B |
| contamination upon | | | | | |
| processing | | | | | |
| Zipping | (−) | A | A | A | A |
| Visual inspection property | (−) | A | B | A | B |
| Polarization inspection | (−) | A | B | A | B |
| property | | | | | |
| Total evaluation | (−) | A | B | A | B |

TABLE 2

| Comparative Examples | (Unit) | 1 | 2 | 3 | 4 |
|---|---|---|---|---|---|
| First release film | | | | | |
| Film thickness | (μm) | 50 (2.5/45/2.5) | | | |
| Coating amount of component of | (g/m²) | 0 | | | |
| coating layer 14 | | | | | |
| Composition of silicone-based | (−) | 1 | 2 | 3 | 6 |
| release layer 15 | | | | | |
| Coating amount of silicone-based | (g/m²) | 0.25 | 0.12 | 0.08 | 0.12 |
| release layer 15 (after dried) | | | | | |
| Amount of migration component in | (wt. %) | 15 | 5 | 5 | 6 |
| release agent composition | | | | | |
| 502 Tape: | | | | | |
| Peel force of release film | (mN/cm) | 12 | 19 | 19 | 20 |
| 31B Tape | | | | | |
| Peel force of release film at | (mN/cm) | 9 | 16 | 30 | 21 |
| 300 mm/min | | C | A | C | C |
| Peel force of release film at | (mN/cm) | 21 | 65 | 71 | 53 |
| 10000 mm/min | | | | | |
| Ratio between peel forces at | (−) | 2.3 | 4.1 | 2.4 | 2.6 |
| 300 mm/min and 10000 mm/min | | A | C | A | C |
| Residual adhesion rate | (%) | 59 | 100 | 100 | 91 |
| Martens' hardness of surface | (N/mm²) | 447 | 454 | 398 | 421 |
| layer | | C | B | D | C |
| Contamination of rolls upon | (−) | B | A | C | B |
| processing (amount of OL generated) | | | | | |
| Amount of OL in film | (mg/m²) | 3.26 | 3.26 | 3.26 | 3.26 |
| Peel characteristic relative to | (−) | A | A | A | C |
| adhesive | | | | | |
| Second release film | | | | | |
| Longitudinal draw ratio | (times) | 3 0 | | | |
| Lateral draw ratio | (times) | 4.3 | | | |
| Film thickness | (μm) | 75 (3.75/67.5/3.75) | | | |
| Coating amount of component of | (g/m²) | 0 | | | |
| coating layer 24 | | | | | |
| Composition of silicone-based | (−) | 5 | | | |
| release layer 25 | | | | | |
| Coating amount of silicone-based | (g/m²) | 0.12 | | | |
| release layer 25 (after dried) | | | | | |
| 502 Tape: | | | | | |
| Peel force of release film | (mN/cm) | 67 | 67 | 67 | 60 |
| Amount of OL in film | (mg/m²) | 3.31 | 3.31 | 3.31 | 3.31 |
| MOR_C value | (−) | 2.1 | 2.1 | 2.1 | 2.1 |
| | | A | A | A | A |
| Thickness Ratio of second | (−) | 1.5 | 1.5 | 1.5 | 1.5 |
| release film/first release film | | | | | |
| Degree of process contamination | (−) | C | A | A | B |
| upon processing | | | | | |
| Zipping | (−) | C | C | C | C |
| Visual inspection property | (−) | B | B | B | B |
| Polarization inspection property | (−) | B | B | B | B |
| Total evaluation | (−) | C | C | C | C |

### EXPLANATION OF REFERENCE NUMERALS

10: Substrateless double-sided adhesive sheet; 11: Adhesive layer; 13: First release film substrate; 14: First coating layer; 15: First release layer; 23: Second release film substrate; 24: Second coating layer; 25: Second release layer; 31: First release film (light-peel sheet); 32: Second release film (heavy-peel sheet)

1. A substrateless double-sided adhesive sheet comprising an adhesive layer, a first release film laminated on one surface of the adhesive layer and a second release film laminated on another surface of the adhesive layer,
which first release film comprises a biaxially oriented polyester film and a release layer formed on the polyester film,
which release layer comprises a silicone resin comprising an alkenyl group and alkyl group as functional groups and a migration component, and a platinum-based catalyst, and
which release layer has a residual adhesion rate of 60 to 90%, a low-speed peel force of 10 to 20 mN/cm as measured at a rate of 300 mm/min, and a high-speed peel force being not more than 2.5 times the low-speed peel force as measured at a rate of 10000 mm/min, as well as a Martens' hardness of not less than 400 N/mm² as measured at a testing force of 0.10 mN using a triangular pyramid indenter with an apex angle of 115°.

2. The substrateless double-sided adhesive sheet according to claim 1, further comprising a coating layer obtained by applying a coating solution comprising polyvinyl alcohol between the biaxially oriented polyester film and the silicone-based release layer.
